(19) United States
(12) Patent Application Publication
(10) Pub. No.: US 2025/0095031 A1
(43) Pub. Date: Mar. 20, 2025

(54) Marketing Display Systems and Methods

(71) Applicant: Quad/Graphics, Inc., Sussex, WI (US)

(72) Inventor: Kenneth Stanley Olson, Apex, NC (US)

(73) Assignee: Quad/Graphics, Inc., Sussex, WI (US)

(21) Appl. No.: 18/902,380

(22) Filed: Sep. 30, 2024

Related U.S. Application Data
(63) Continuation of application No. 15/342,055, filed on Nov. 2, 2016.
(60) Provisional application No. 62/249,760, filed on Nov. 2, 2015.

(51) Int. Cl. G06Q 30/0241; G06F 3/147; G06V 40/10; G06V 40/20; H04L 67/02; H04L 67/52

(52) U.S. Cl. CPC G06Q 30/0277; G06F 3/147; H04L 67/02; H04L 67/52; G06V 40/10; G06V 40/20; G09G 2340/0407; G09G 2370/12; G09G 2370/16

(57) ABSTRACT

Technologies are disclosed for creating a digital signage system and network that can be installed in retail stores by brands at a reduced cost versus the current market while also creating as little disruption as possible for the retail store. Such technologies can enable a distributed digital signage network for brands to be deployed in a short period of time across a broad range of drugstore, grocery-store and super-store retailers. Other embodiments are also disclosed and described herein.

### CROSS REFERENCE TO RELATED APPLICATIONS

This application is a continuation of application Ser. No. 15/342,055, filed Nov. 2, 2016, which claims the benefit of U.S. Provisional Patent Application Ser. No. 62/249,760, filed on Nov. 2, 2015, entitled “MARKETING DISPLAY SYSTEMS AND METHODS,” the disclosures of which are hereby incorporated by reference in their entireties.

### TECHNICAL FIELD

The subject application teaches example embodiments that relate generally to digital advertising displays and specifically to in-store digital marketing displays for presenting information about products on shelves in supermarkets, stores, and businesses.

### BACKGROUND

Supermarkets, stores, and businesses use multilevel shelves arranged in isles to display items for sale to consumers. Items are generally organized by placing similar items near to one another on the shelves. Items offered for sale can be produced by the same manufacturer or different manufacturers depending upon the store. To promote the sale of one or more items, manufacturers can pay for product placement in premium locations. For example, a manufacturer can request that certain items be placed on shelves that are at eye-level to consumers or placed on shelves positioned at the end of isles, sometimes called end caps, where products are more likely to be seen and selected by consumers.

Manufacturers sometimes produce marketing displays to accompany their products. Often these displays are static displays. Static displays can be, for example, a piece of embossed cardboard or plastic that has been printed with any suitable combination of a picture of one or more products, the name of the products, and the brand or manufacturer of the product. Often the static displays are larger than the product, use bright colors or lettering to attract the attention of consumers, and are shaped to highlight the product or a particular marketing aspect associated with the product. Example marketing aspects can include a discount, a promotion, or a trade dress feature such as a character or characters that are used to promote the product. Static displays require someone to set up the display and position the products appropriately near or in the display. Once the display is initially set up, consumers passing by the display remove products for purchase. An employee periodically restocks the shelves to replace removed items. The employee restocking the shelves may position products somewhat differently than anticipated by the designer of the static display. Over time the display may wear or become damaged and parts of the display may be removed, either by accident or purposefully. Sometimes parts of a display are never installed during the initial set up. Therefore, it is not uncommon for the displays and product placement to be substantially different from what is expected by the manufacturer. A manufacturer therefore may have incomplete or limited knowledge of the effectiveness of the display or product positioning in affecting consumer purchasing behavior.

### BRIEF DESCRIPTION OF THE DRAWINGS

It is believed that certain embodiments will be better understood from the following description taken in conjunction with the accompanying drawings, in which like references indicate similar elements and in which:

FIG. 1 is a simplified block diagram of at least one embodiment of a product shelf that includes a marketing display;

FIG. 2 is a simplified block diagram of at least one embodiment of the marketing display of FIG. 1 with a consumer focused presentation;

FIG. 3 is a simplified block diagram of at least one embodiment of the marketing display of FIG. 1 with an employee focused presentation;

FIG. 4 is a simplified block diagram of at least one embodiment of the marketing display of FIG. 1 with an inventory focused presentation;

FIG. 5 is a simplified block diagram of at least one embodiment of the marketing display of FIG. 1 with a consumer action focused presentation;

FIG. 6 is a simplified block diagram of at least one embodiment of the marketing display of FIG. 1 with a consumer identity focused presentation;

FIG. 7 is a simplified block diagram of at least one embodiment of the marketing display of FIG. 1 with a real-time promotion presentation;

FIG. 8 is a simplified flow diagram of at least one embodiment of a process that may be executed by the marketing display of FIG. 1;

FIG. 9 is a simplified block diagram of at least one embodiment of example components of a marketing display;

FIG. 10 is a simplified flow diagram of an example electrical connection system for use with the marketing display of FIG. 1 according to one embodiment;

FIG. 11A is an exploded diagram of at least one other embodiment of a marketing display;

FIG. 11B is an isometric diagram of at least one embodiment of the marketing display of FIG. 11A installed on a product shelf;

FIG. 12 is a right front isometric view diagram of a marketing display assembly in a closed position according to one embodiment;

FIG. 13 is a right back isometric view diagram of the marketing display assembly of FIG. 12;

FIG. 14 is an exploded right front isometric view diagram of the marketing display assembly of FIG. 12; and

FIG. 15 is a right elevational view of the marketing display assembly of FIG. 12 in an open position according to one embodiment.

### DETAILED DESCRIPTION

Various non-limiting embodiments of the present disclosure will now be described to provide an overall understanding of the principles of the structure, function, and use of the systems, apparatuses, devices, and methods disclosed herein. One or more examples of these non-limiting embodiments are illustrated in the selected examples disclosed and described

in detail with reference made to the figures in the accompanying drawings. Those of ordinary skill in the art will understand that the systems, apparatuses, devices, and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

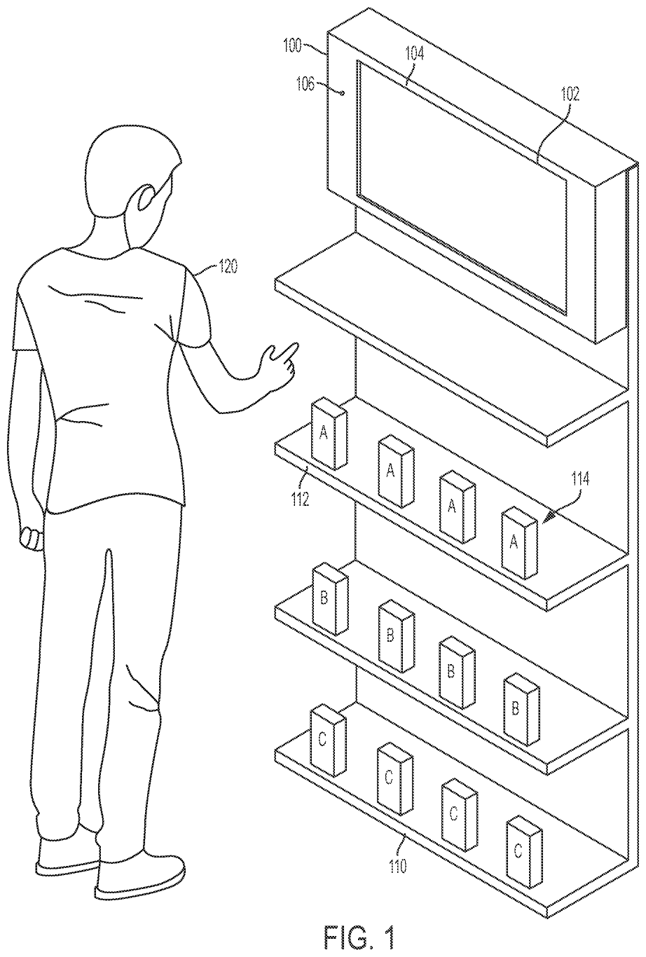

Referring now to FIG. 1, a marketing display 100 can be secured to a multilevel shelf 110. Products 114, such as products A, B, and C as shown, can be placed on shelf trays 112 of the shelf 110 for consumers 120 to select for purchase. Products 114 are typically items that are produced by the same manufacturer, but in various configurations can be the same item, different items from the same manufacturer, related items from different manufactures, or completely different items as would be understood by one of ordinary skill in the art.

The marketing display 100 can include a display screen 102, a frame or surround 104, and a camera or sensor 106. In an embodiment, the display screen 102 does not include the surround 104. In an embodiment, the sensor 106 is separate from the marketing display 100. The display screen 102 can be configured to present a video clip, a static image, or any other content to consumers 120, employees, or the like. For example, display screen 102 can present a repeating video clip, a streaming video clip, a series of static images, a single static image, or any suitable combination as would be understood in the art.

The marketing display 100 can include a surround 104 to advertise one or more of the items A, B, C. For example, the surround 104 can use a color scheme and include the name of the product 114, the brand, or the manufacturer. In various configurations, the surround 104 can be permanently attached to the marketing display 100, or attached via a removable attachment means such as hook-and-loop materials, magnetic coupling, tape, or any other material suitable for semi-permanent attachment of the surround 104 to the marketing display 100. In various configurations the surround 104 can be attached to the bezel of the display screen 102, to a portion of the bezel of the display screen 102, or to the marketing display 100 for example if the display screen 102 has a narrow bezel or does not have a bezel. The surround 104 can also include a digital display that can operate independently or in concert with the display screen 102. Each shelf 110 or shelf tray 112 can also be associated with a separate visual display or screen that can be coordinated or separate from the other display screens described herein. It will be appreciated that some or all of the display screens can be touchscreens or can otherwise be interactive with a consumer, employee, or the like. It will be appreciated that a visual display on the shelf 110 could light up to highlight a product, such as by lighting up underneath a product, when that product is being featured on the display screen 102.

The marketing display 100 can include a sensor 106. In various configurations, the sensor 106 can sense the presence of a consumer 120, employee, or the like, in proximity to the shelf 110, aspects about the consumer 120 including visible or electromagnetic detectable aspects, presence of products 114, or aspects about the products 114. In various configurations, the sensor 106 can be a camera, an infrared detector, a pressure sensor, a contact sensor, and so forth.

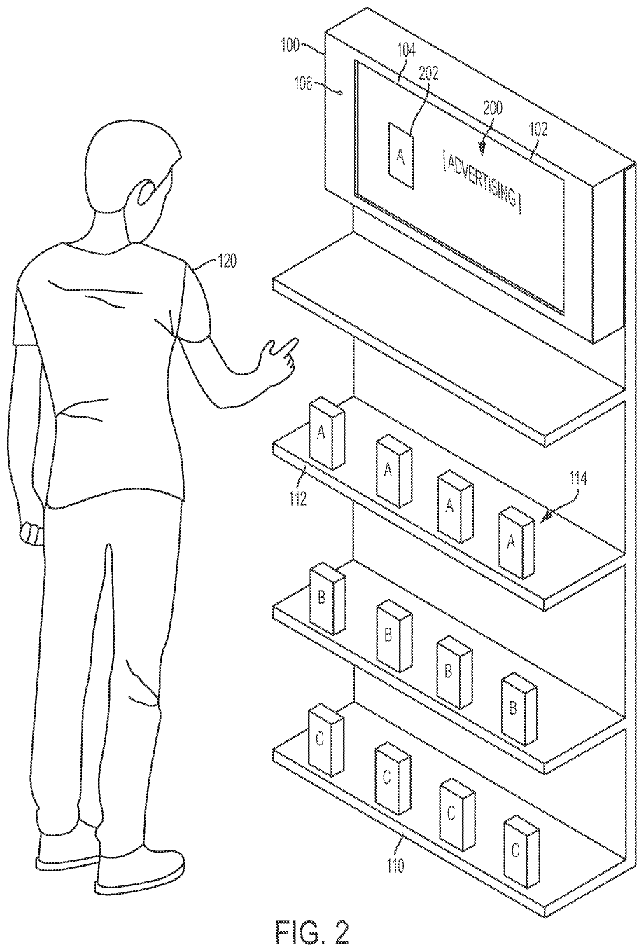

The marketing display 100 can be a multimodal display and can operate in different display modes. Referring now to FIG. 2, the marketing display 100 can operate in a first display mode 200 in which the display screen 102 can present a prescribed product-load for the particular marketing display 100. For example, in the first display mode 200 the display screen 102 can present a consumer-focused or shopper-focused communication, such as an advertisement 202 promoting one of the products 114 such as product A (as shown), or any other products 114 or combinations of products 114 as desired by the manufacturer or store. In various configurations, the first display mode 200 can be configured to operate during select times, such as during store hours or when a consumer 120 is detected in proximity to the shelf 110 by the sensor 106.

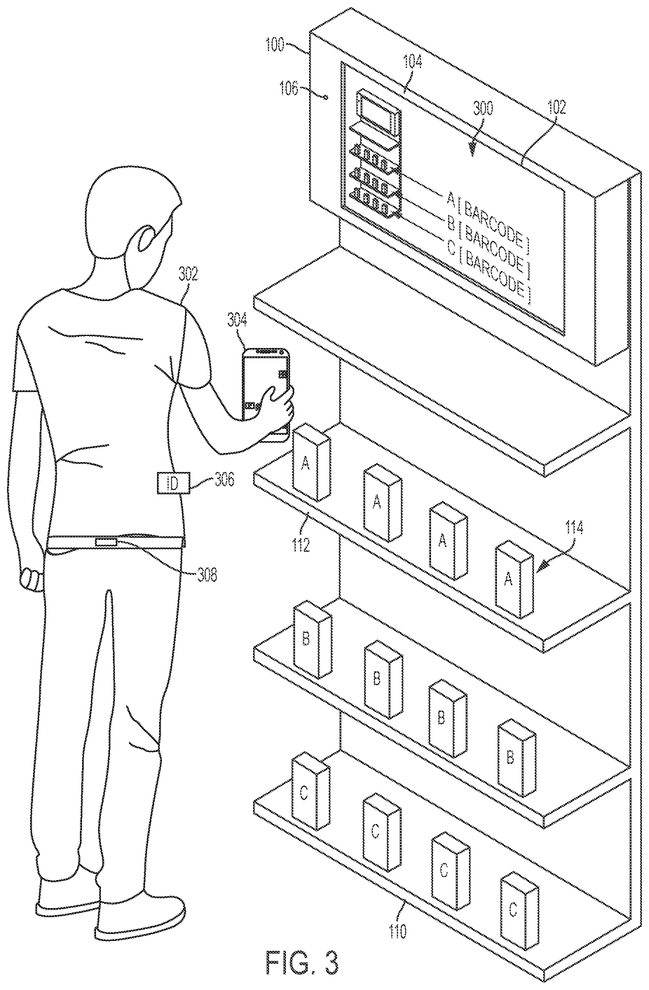

Referring now to FIG. 3, the marketing display 100 can operate in a second display mode 300 in which the display screen 102 can switch from the consumer-focused communication to an employee focused presentation. In one such configuration, the second display mode 300 can display an image or video that includes the configuration of the shelf 110, an image of each product 114, the desired placement of products 114 on the shelf trays 112, and a scannable UPC barcode for each product 114. Such product load information can assist the employee in properly configuring the shelf 110 and products 114 according the desire of the manufacturer or store. In this configuration, the employee 130 can read the code from the display screen 102 with a bar code scanner to determine if one or more of the products 114 are in stock so as to determine whether to restock the shelf 110 or order more products 114. In various configurations, the second display mode 300 can be configured to operate during select times, such as during hours in which the store is closed, or when an employee 302 is detected by the sensor 106. In various embodiments, the employee 302 can be detected through a mobile app that is executing on a smartphone 304, detection of an employee badge 306 by the sensor 106, detection of a signal from an employee transponder 308 such as an RFID or other device (that in an embodiment can be incorporated into the employee identification badge 306), or facial recognition or other recognition of the employee 302 by the sensor 106 for example by identifying an employee uniform or article of clothing. In an configuration, the smart phone 304 can interact with the sensor 106 of the marketing display 100 through any suitable means, including but not limited to networked communications, point-to-point wireless communications such as BLUETOOTH, !BEACONS, or NFC (near field communications), or any suitable visual or audio cues produced by the smartphone 304 sensed by the sensor 106. In various configurations, the marketing display 100 can operate in the second display mode 300 by executing software in the marketing display 100 or by receiving information from a separate computer system to which the marketing display 100 is in communication.

The one or a plurality of sensors 106 can also operate to confirm that the products are placed in the correct location on the shelf 110, have the correction orientation, or the like. For example, the sensor 106 can monitor the orientation of a label or a feature on a label such that if the orientation is not facing in the proper direction a message or visual indicator can be provided on the display screen 102. One or a plurality of sensors 106 can cooperate to confirm that one or a plurality of products are properly positioned on a shelf 110, for example. In one embodiment, a first sensor can be a weight sensor positioned on a shelf tray 112 and a second sensor can be a camera with a line of sight to the shelf tray 112. The first sensor can monitor the weight of a product to determine if it matches a pre-programmed database and the second sensor can monitor the label of the product to confirm that the product is correct and facing the correct direction. It will be appreciated that any suitable number of sensors can be used to properly align and identify products. In one embodiment, a sensor can identify expiration date information on a product label and can communicate to an employee via the display screen 102 that the product has expired. In one embodiment such communication with the employee may be done m an unobtrusive manner such that a consumer is not aware of what the visual indicator means.

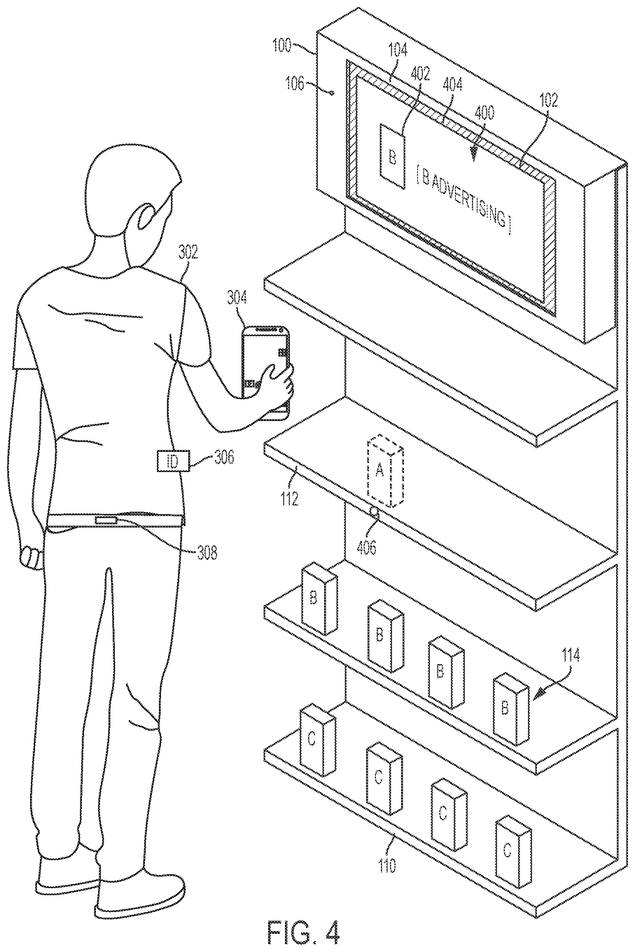

Referring now to FIG. 4, the marketing display 100 can operate in a third display mode 400 in which the display screen 102 can display product related information based at least in part on data from one or more sensors 106 about the products 114 on the shelf 110. For example, a sensor 106 can detect the presence or absence of one or more products 114 on one or more of the shelves 114. For example, sensor 106 can be a camera that can detect that product A is no longer available on the shelf 110. In another configuration, pressure sensor 406, as illustrated in FIG. 4, can detect that product A is not present on the shelf 110. In other configurations, the sensor 106 can be a sensor on a peg board, a weight sensor that can detect the relative number of products 114 on the shelves 114, or any other sensor 106 or combination of sensors as would be understood by one of ordinary skill in the art.

In response to the detected condition by the one or more sensors 106, 406, the marketing display 100 can operate in the third display mode 400. In the third display mode 400, the display screen 102 can present a consumer-focused advertisement based at least in part on the products 116 sensed by the sensors 106, 406. For example, the consumer-focused advertisement can switch to showing only advertisements 402 related to the products 114 present on the shelf 110 such as product B (as shown) or product C. In another configuration, the display screen 102 can present the consumer-focused advertisement along with a visual indicator 404 that product A is sold out that would be obvious to an employee, but not necessarily a consumer. Example visual indicators 404 can include, but are not limited to, a border color presented on the display screen (as shown), a different background color for the consumer-focused advertisement, and a visual beacon such as a flashing portion or a separate LED (light emitting diode; not shown). A visual display associated with the specific shelf or even product (not shown) is also contemplated to indicate a sold out or improperly placed product. Other indicators could also be used as would be understood by one of ordinary skill in the art. In a configuration, the third display mode 400 can be combined with the detection of an employee 302 as described above for FIG. 3, in which case the display indicator can be made conditional upon the detection of the employee 302 being proximate the marketing display 100. In another configuration, in response to the detected condition of the presence or absence of one or more products 114 by the one or more sensors 106, 406, the marketing display 100 can send information directly, or indirectly, to the store, to a store employee, and/or to a manufacturer. For example, the marketing display 100, or another computer system in communication with the marketing display 100, can send a communications such as an email, text, message, phone call, smartphone push notification, NFC or BLUETOOTH communication, or any other suitable communication as would be understood by one of ordinary skill in the art. In another configuration, response to the detected condition of the presence or absence of one or more products 114 by the one or more sensors 106, 406, can be used to generate restocking or reordering information. In a configuration, the detected condition can be used to correlate, or cross-reference, the presence or absence of products 114 on the shelf 110 with sales data to show the impact of on sales of a product with availability of the product 114 on the shelf 110.

In one embodiment, pressure sensors 406 can be embedded in a mat (not shown) that can be placed upon a shelf 110 and that are in communication with a display screen 102. In a modular unit the display screen can be shipped with a plurality of mats containing pressure sensors, where the pressure sensors can communicate with the display screen 102 and an associated controller via BLUETOOTH, a local area network, WiFi, or the like. The display screen 102 can be easily set up by an employee and the mats with embedded sensors can be associated with a standard shelving unit. The controller associated with the display can, in one embodiment, determine the distance and relationship of the sensors to the display screen and to one another to provide a template for the arrangement of products. Alternatively, once an employee has placed pressure sensors in desired locations they can “teach” the controller associated with the display screen 102 which products having which characteristics should be placed in which locations. Once this baseline is established the controller can indicate via the display screen any variation or deviation from this baseline setup. It will be appreciated that any suitable number and type of sensors can be prepackaged or otherwise provided in any suitable form. Sensors can be embedded in plastic sheets, within a rigid or semi-rigid tray or liner, can be coupled wirelessly or with wired connections, and can monitor any suitable feature or characteristic of a product. In one embodiment, the sensors can be physically attached to the products such as with a sticker, suction cup, covering, wrap, lanyard, or the like. Such sensors associated with the products can be used independently or could be used in combination with sensors associated with the fixture or modular display such that position, sales, movement, and the like can be detected.

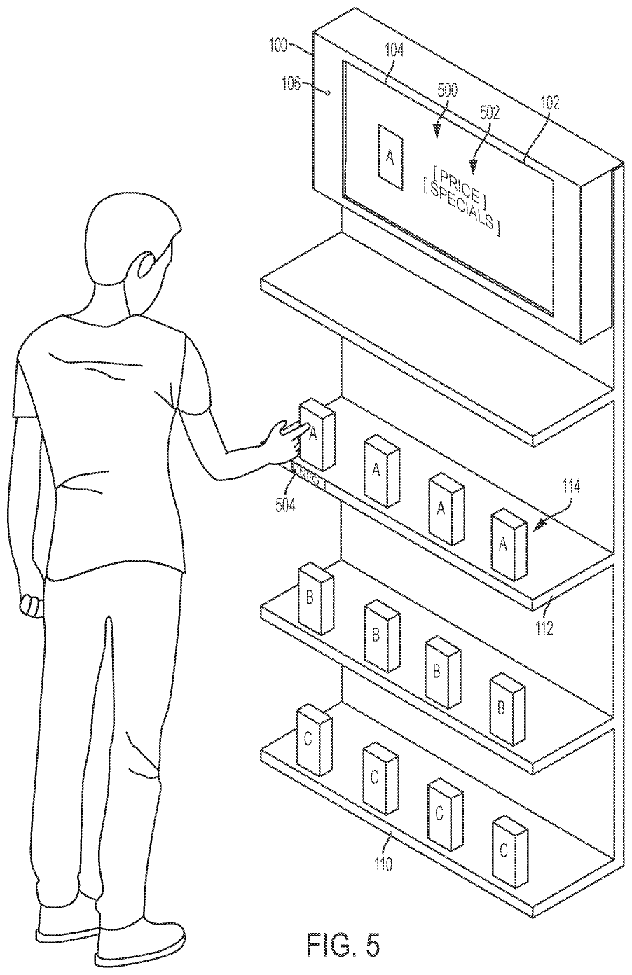

Referring now to FIG. 5, the marketing display 100 can operate in a fourth display mode 500 in which the display screen 102 can display product related information based at least in part on the actions of a consumer 120. A sensor 106 can detect an action of a consumer 120 and modify the fourth display mode 500 accordingly. For example, if a sensor 106 detects that the consumer has touched or is picking up a product 114, the fourth display mode 500 can display product specific information 502 about the product 114. The marketing display 100 could also initiate a visual feature, such as a light on the shelf where the product is located, associated with that product. Product specific information 502 can include, but is not limited to, the price of the product 114, the price per unit of the product 114, discounts for purchasing the product 114 in multiple units, related products, nutritional information, and so forth. In another configuration, the consumer 120 can press an information sensor 504 to receive information. In a configuration, the information sensor 504 can be a passive sensor, such as a sticker, tag, or zone on the shelf 110 and the sensor 106 can detect the presence of an appendage of a consumer 120 in proximity to the information sensor 504. In another embodiment, the sensor 106 can be a touch sensitive portion of the marketing display 100, for example a touch sensitive display screen 102. In an embodiment, when the consumer 130 has selected and removed the product

114 from the shelf 110, the fourth display mode 500 can thank the consumer 120. In a configuration, the sensor 106 can detect when the consumer 120 has placed the selected product 114 in a shopping cart and thank the consumer 120 after the detection. In a configuration, a shopping cart can include a sensor and be in communication with the marketing display 100. In one embodiment, specific products can be associated with specific locations such that a consumer might win a prize a check-out for selecting a lucky product from the shelf The lucky product can have the location and associated UPS or identifying information recorded such that the consumer only wins the prize, coupon, or the like upon completing the purchase of the lucky product. Embodiments of gamification for shopping applications are contemplated, where consumers can earn points, prizes, discounts, and the like by taking certain actions detected by the display system and associated components.

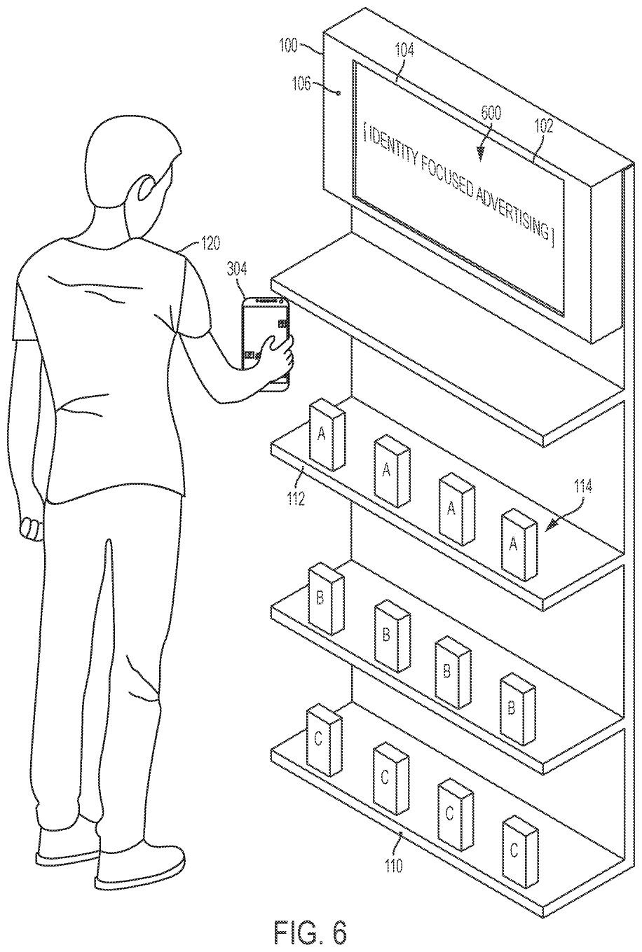

Referring now to FIG. 6, the marketing display 100 can operate in a fifth display mode 600 in which the display screen 102 can display product related information based at least in part on the identify of a consumer 120. In this embodiment, the marketing display 100 can identify the identity of the consumer 120 or an identifying characteristic of a consumer 120. In a first configuration, the consumer 120 can be identified by a smartphone 304 carried by the consumer 130. For example, the consumer 120 can be identified using query-response or push-notifications from an app on the smartphone 304, by identifying a mac address associated with the smartphone 304, NFCs, or by other suitable means for identifying the smartphone 304 and correlating that information with the consumer 120 or the previous purchases of the consumer 120. In a second configuration, the identity of the consumer 120 can be identified using facial recognition by the sensor 106, for example a high resolution camera. In a third configuration, an identifying characteristic of the consumer 120 can be identified. For example, the consumer 120 may be wearing a hat or shirt that identifies a particular sports team. Based at least in part on either the identity of the consumer 120, or an identifying characteristic of the consumer 120, the marketing display 100 can operate in a fifth display mode 600. In the fifth display mode 600, the display screen 102 can present a consumer-focused advertisement that is tailored to the identity of, or an identifying characteristic of, the consumer 120. For example, the fifth display mode 600 can display a sport-related advertisement for a consumer 120 based on the detection. For example, if the product 114 is detergent, then the fifth display mode 600 can present a customized advertisement directed to removing stains that occur from sports-related activities. In another example, the fifth display mode 600 can display a health-related advertisement. For example, if the marketing display 100 can correlate the consumer 120 with a health related issue such as diabetes, or previous healthy choice purchases, then the fifth display mode 600 can switch to an advertisement for the low-sugar, or low-fat version of the product 114. In a configuration, the fifth display mode 600 can direct the consumer 120 to the placement of a product 114 on the shelf 110. The fifth display mode 600 can be configured to display advertising specific to the age, gender, nationality, purchase history, geographic location, or any other demographic of the consumer 120 as would be understood by one of ordinary skill in the art. It will be appreciated that a plurality of displays, such as visual displays associated with specific shelves or products, can be used in accordance with embodiments described herein.

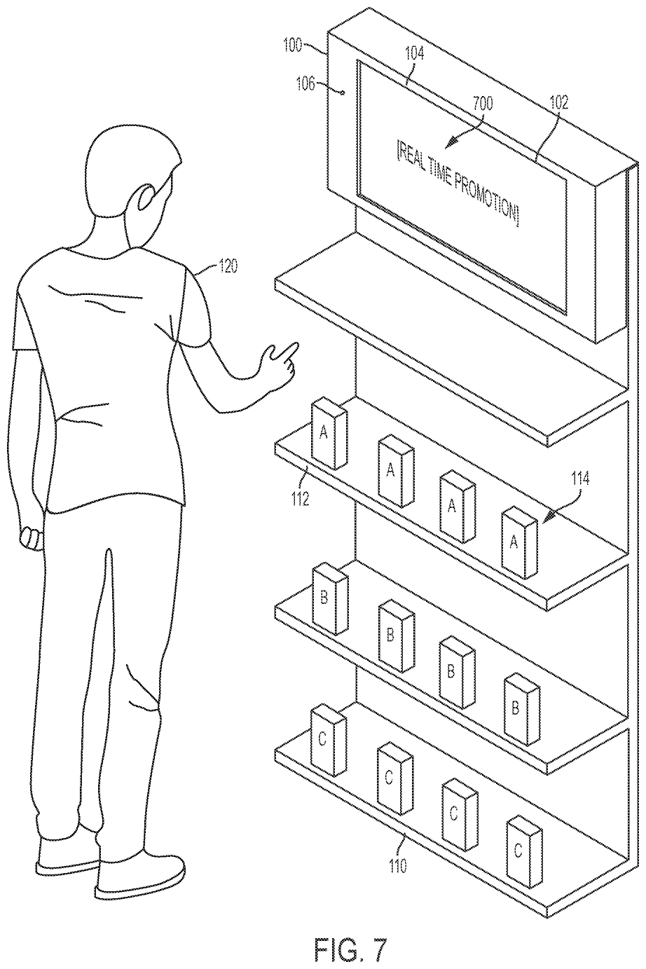

Referring now to FIG. 7, the marketing display 100 can operate in a sixth display mode 700. In the sixth display mode 700, the display screen 102 can present real-time promotions or real-time information about products 114. For example, the sixth display mode 700 can present price promotions as they become available in real-time. For example, if a 2 for 1 promotions starts on a first date and ends on a second date, the sixth display mode 700 can display a promotional video while the promotion is active. In a configuration, the promotional video of the sixth display mode 700 can alternate with other display modes 200, 300, 400, 500, and 600 or be displayed periodically. In a configuration, the sixth display mode 700 can indicate to the consumer 130 the duration of the promotion. In another example, the sixth display mode 700 can present other real-time information to consumers 130, for example the levels of stock of particular products 114 in the store. In a configuration, the sixth display mode 700 can also present information about where the out-of-stock products 114 are in stock, for example at other nearby stores or online. In another configuration, the sixth display mode 700 can present comparative pricing, manager specials, or other information of importance to consumers 130.

Referring generally to FIGS. 1-7 above, and specifically to FIGS. 6 and 7, in various embodiments, the marketing display 100 can be configured to provide analytic data about the consumer to the store, to a manufacturer, or to another third party. Analytic data can include, but is not limited to, information about consumer activity such as consumer traffic near the marketing display 100 as sensed by one or more sensors 106, consumer dwell time at the marketing display 100, consumer identifiable demographic information, consumer purchase behavior at the marketing display 100, and consumer purchase history. In an embodiment, captured video of consumers can be gathered by the marketing display 100. Analytic data can help to determine the amount of walk-by traffic, determine the number of glances by consumers at the marketing display 100, determine whether the marketing display 100 has garnered the attention of consumers, determine if a consumer 120 has engaged with the products 114 or the marketing display 100, and whether the engagement has resulted in a purchase of a product 114 or repurchase of a product 114. Analytic data can assist stores, manufacturers, advertisers, and other parties in understanding the effectiveness of advertising, promotions, consumer loyalty, and consumer behavior in general. Other analytic data can also be determined as would be understood by one of ordinary skill in the art. In an embodiment, consumer data and analytic data can be anonymized or tokenized to safeguard the identity of consumers and ensure that the marketing display 100 complies with any applicable privacy laws, regulations, or policies.

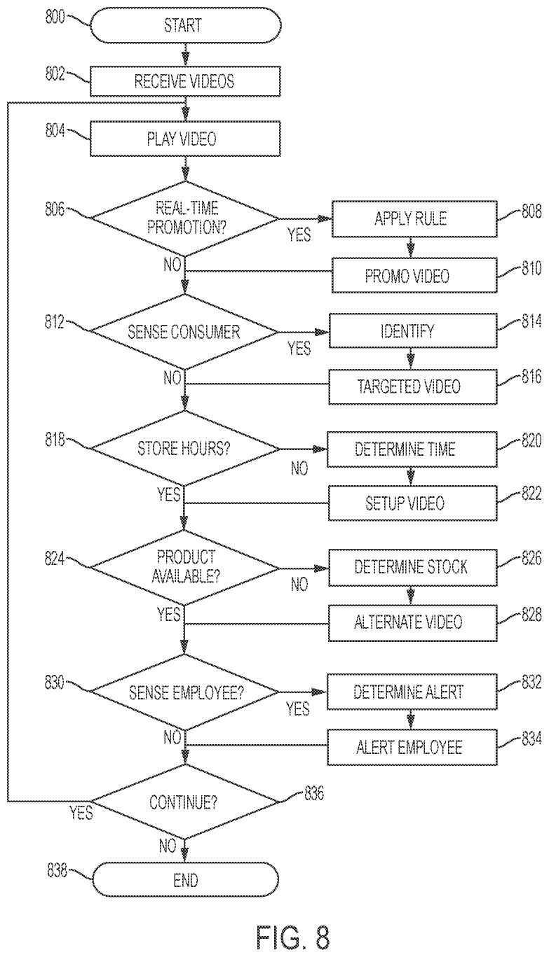

Referring also to FIG. 8, an example flow diagram of example processes for a marketing display is presented. Processing begins at start block 800 and continues to process block 802.

At process block 802, the marketing display receives one or more videos. In a configuration the marketing display can receive multiple videos that are stored in memory and played at the appropriate time. For example, the marketing display can receive the default consumer focused video to be played as the selected video as well as one or more alternative videos that are to be played if certain conditions are met, as described below. In another configuration, the marketing display receives a live video stream of the video that is to be contemporaneously played in real-time. Processing continues to process block 804.

At process block 804, the marketing display plays the selected stored video or live video stream to the display device of the marketing display. In a configuration, there can be multiple videos that are played using a schedule or rotation. For example, multiple manufacturers can have videos of different products advertised through the same marketing display. Processing continues to process block 806.

At decision block 806, if there is a real-time promotion for a product, then processing continues to process block 808, otherwise, then processing continues to process block 812.

At process block 808, a rule is applied to determine whether a real-time promotional video is to be played. For example, a store special, a manager's special, or a manufacturer's special can be available to consumers during a specific time period. Processing continues to process block 810.

In process block 810, the promotion video is played on the marketing device. In a configuration, the promotion is added to a schedule which causes the promotional video to play periodically in addition to the default videos. Processing continues to decision block 812.

In decision block 812, if a consumer is sensed by a sensor of the marketing device, then processing continues to process block 814, otherwise processing continues to decision block 820.

In process block 814, the marketing display identifies the consumer or an activity of the consumer. For example, as described above, a sensor of the marketing display can determine the identity of the consumer or an identifying characteristic of the consumer. In another example, a sensor can determine the activity of the consumer, such as whether the consumer picks up a product, places a product into the consumer's shopping cart, or touches an area of the display requesting additional information. Processing continues to process block 816.

In process block 816, based at least in part on the identity of the consumer or an activity of the consumer, the marketing display can play a targeted video. For example, if the consumer has been specifically identified, then the targeted video can be a video that is directed to a known interest of the consumer, such as an advertisement that refers to sports activities for one consumer, or health related product interests such as low sugar or low fat products for another consumer. In a configuration, the selected video can be based on previous purchases by the consumer or other items the consumer has placed in the consumer's shopping cart. In yet another example, the video can be directed to an identified demographic and based upon characteristics such as age or gender. The selected video can also be based upon the action of the consumer, for example by selected a video to play that describes the features, price, or available discounts about an item selected by the consumer. In yet another example, the selected video can be a short thank you presented to the consumer when a selected item is placed in the consumer's shopping cart. Processing continues to decision block 818.

In decision block 818, if the video to be selected is based on store hours, then processing continues to process block 820, otherwise processing continues to decision block 824.

In process block 820, the marketing display determines if the store is open or closed, for example based upon the store's schedule or based upon environmental conditions sensed by a sensor, for example whether lights are on in the store. Processing continues to process block 822.

At process block 822, if the store is determined to be closed, then a video can be selected that would assist store employees in restocking the shelves. For example, a video can be selected that shows the expected setup of the products on the shelves associated with the marketing display. The video can include, among other things, pictures of the products to be placed on the shelves and barcodes of the products. Employees can scan the barcodes, for example using a bar code scanner. The barcodes can be used by the employees to assist them in determining whether the product is in stock, and which product to place on which shelf tray. Processing continues to decision block 824.

At decision block 824, if the products on the shelf are being sensed, then processing continues to process block 826, otherwise processing continues to decision block 830.

At process block 826, the marketing device determines which products are in stock. For example, one or more sensors can determine whether products have been removed from the shelves or whether a particular product is still on the shelf Example sensors can include a camera sensor, a weight sensor configured to sense when a product is on a shelf, a contact sensor, a capacitive sensor, and so forth. In an embodiment, an alert such as an email, text message, or push notification can be sent to a store employee, the store, and/or a manufacturer that provides information about whether one or more products are on the shelves or in stock. Processing continues to process block 828.

At process block 828, the marketing device can select an alternative video based the determination of whether a product is on the shelf or in stock. For example, if the default consumer focused video advertises a particular product that is not on the shelf or in stock, then the marketing device can select a video that advertises another product that is on the shelf or that is in stock. Processing continues to decision block 830.

At decision block 830, if a sensor detects an employee is in proximity to the marketing device, then processing continues to process block 832, otherwise processing continues to decision block 836.

At process block 832, if an employee is in proximity to the marketing device, then the marketing device determines the appropriate alert to present to the employee. For example, if the shelf is out of inventory or low on inventory, the marketing device may present an alert such as a change in the background color of the advertisement or the addition of a colored border to the video in order to get the attention of the employee. Such an alert can be used to prompt the employee to restock or reorganize the shelves with the desired products. In another example, if the marketing device has previously determined that the store is not currently open, then the marketing device can select an employee focused video to play. As disclosed above, an example employee focused video can include a video that includes the barcodes of products to be restocked on the shelves. Another example video can include instructions and graphics of how the manufacturer expects the shelves to be stocked with the manufacturer's products. Processing continues to decision block 836.

A decision block 836, if the marketing device continues to present advertisements and other videos, then processing continue back to process block 804 to play the selected video, otherwise processing terminates at end block 838.

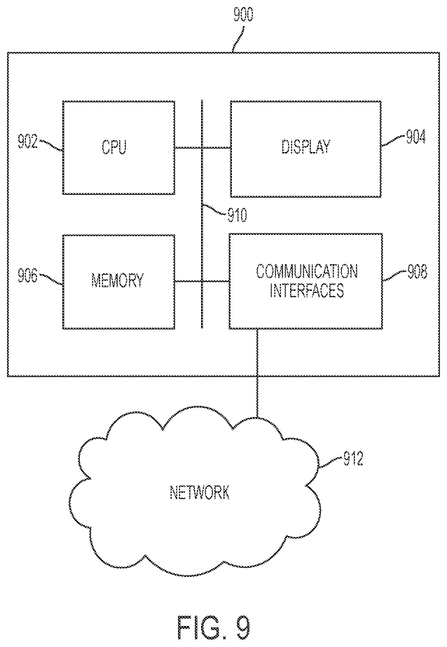

The functions and processes of the marketing device can be performed on or between one or more computing devices 900. Referring now to FIG. 9, an example computing device 900 is presented. A computing device 900 can be a server, a computing device that is integrated with other systems or subsystems and can use cloud-based computing capability. The marketing display can use any suitable computing device 900 as would be understood in the art, including without limitation, a custom chip, an embedded processing device, a tablet computing device, a smartphone, a personal data assistant (PDA), a desktop, a laptop, a microcomputer, a minicomputer, a server, a mainframe, or any other suitable programmable device. In various embodiments disclosed herein, a single component can be replaced by multiple components and multiple components can be replaced by a single component to perform a given function or functions. Except where such substitution would not be operative, such substitution is within the intended scope of the embodiments.

The computing device 900 includes a processor 902 that can be any suitable type of processing unit, for example a general purpose central processing unit (CPU), a reduced instruction set computer (RISC), a processor that has a pipeline or multiple processing capability including having multiple cores, a complex instruction set computer (CISC), a digital signal processor (DSP), an application specific integrated circuits (ASIC), a programmable logic devices (PLD), and a field programmable gate array (FPGA), among others. The computing resources can also include distributed computing devices, cloud computing resources, and virtual computing resources in general.

The computing device 900 also includes one or more memories 906, for example read only memory (ROM), random access memory (RAM), cache memory associated with the processor 902, or other memories such as dynamic RAM (DRAM), static ram (SRAM), programmable ROM (PROM), electrically erasable PROM (EEPROM), flash memory, a removable memory card or disk, a solid state drive, and so forth. The computing device 900 also includes storage media such as a storage device that can be configured to have multiple modules, such as magnetic disk drives, floppy drives, tape drives, hard drives, optical drives and media, magneto-optical drives and media, compact disk drives, Compact Disk Read Only Memory (CD-ROM), Compact Disk Recordable (CD-R), Compact Disk Rewriteable (CD-RW), a suitable type of Digital Versatile Disk (DVD) or BluRay disk, and so forth. Storage media such as flash drives, solid state hard drives, redundant array of individual disks (RAID), virtual drives, networked drives and other memory means including storage media on the processor 902, or memories 906 are also contemplated as storage devices. It can be appreciated that such memory can be internal or external with respect to operation of the disclosed embodiments. It can be appreciated that certain portions of the processes described herein can be performed using instructions stored on a computer-readable medium or media that direct a computer system to perform the process steps. Non-transitory computer-readable media, as used herein, comprises all computer-readable media except for transitory, propagating signals.

The network and communication interfaces 908 can be configured for communicating locally, or point-to-point, with another computing device, for example using BLUETOOTH, iBeacons, or NFC. The network and communication interfaces 908 can be configured to transmit to, or receive data from, other computing devices 900 across a network 912. The network and communication interfaces 908 can be an Ethernet interface, a radio interface, a Universal Serial Bus (USB) interface, or any other suitable communications interface and can include receivers, transmitter, and transceivers. For purposes of clarity, a transceiver can be referred to as a receiver or a transmitter when referring to only the input or only the output functionality of the transceiver. Example communication interfaces 908 can include wired data transmission links such as Ethernet and TCP/IP. The communication interfaces 908 can include wireless protocols for interfacing with private or public networks 912. For example, the network and communication interfaces 908 and protocols can include interfaces for communicating with private wireless networks such as a WiFi network, one of the IEEE 802.11x family of networks, or another suitable wireless network. The network and communication interfaces 908 can include interfaces and protocols for communicating with public wireless networks 908, using for example wireless protocols used by cellular network providers, including Code Division Multiple Access (CDMA) and Global System for Mobile Communications (GSM). A computing device 900 can use network and communication interfaces 908 to communicate with hardware modules such as a database or data store, or one or more servers or other networked computing resources. Data can be encrypted or protected from unauthorized access.

In various configurations, the computing device 900 can include a system bus 910 for interconnecting the various components of the computing device 900, or the computing device 900 can be integrated into one or more chips such as programmable logic device or application specific integrated circuit (ASIC). The system bus 910 can include a memory controller, a local bus, or a peripheral bus for supporting display devices 904, and communication interfaces 908.

An example display device 904 can include a high definition display module, for example a 32-inch HDTV screen having a native resolution of 1920×1080 or 1280×720. The display device 904 can be configured to be mounted to an end cap of a supermarket display shelf The display device 904 can be configured to be lightweight to facilitate attachment to shelving units. The computing device 900 can be a single unit incorporating the display device 904, or the display device 904 can be separate and connected via a video cable, such as an HDMI (high definition media interface) cable.

In a configuration, the processor 902 and/or display device 904 can convert, or upscale, lower resolution video streams into the native resolution of the display device 904. In this way, advertisers can provide existing low resolution video streams and the manufacturers are not required to update existing product videos for playback on the marketing display.

The processor 902 and memory 906 can include nonvolatile memory for storing computer-readable instructions, data, data structures, program modules, code, microcode, and other software components for storing the computer-readable instructions in non-transitory computer-readable mediums in connection with the other hardware components for carrying out the methodologies described herein. Software components can include source code, compiled code, interpreted code, executable code, static code, dynamic code, encrypted code, or any other suitable type of code or computer instructions implemented using any suitable high-level, low-level, object-oriented, visual, compiled, or interpreted programming language.

In an embodiment, the computing device 900 includes an external power adaptor. For example, the computing device 900 can include an external power adaptor that delivers 120V power, or an external power adaptor that converts 120V power to a lower AC or DC voltage for use by the computing device 900. In various configurations, additional power feeds for powering third party devices can be provided by the external power adaptor or the computing device 900 (not shown). In this manner, power for additional computing devices 900 or third party devices can be powered from the external power adaptor or from an optional adaptor plug in the body of the marketing display (not shown).

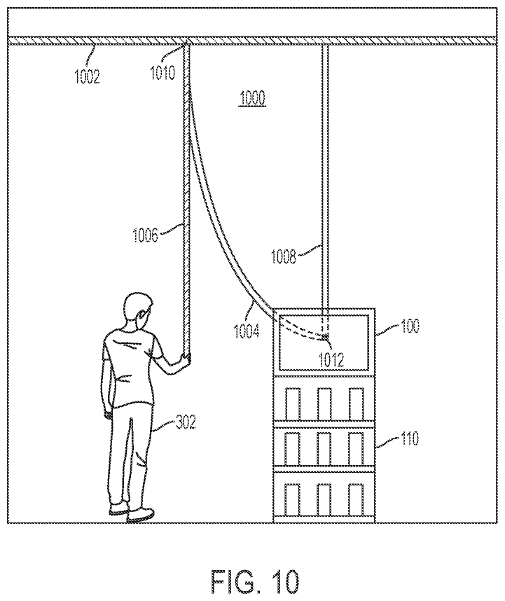

Referring now also to FIG. 10, an example electrical connection system 1000 is presented. In the electrical connection system 1000, an electrified track 1002 is installed in the store. Many stores have structured, open ceilings making it relatively straightforward to install one or more electrified tracks 1002 (e.g., distributed tracks) against the ceiling of the store or along beam structures. The electrified track 1002 facilitates providing power to the marketing display 100. The electrified track 1002 can be any suitable voltage and can be AC or DC depending upon the particular installation. It will be appreciated that the electrified track and be associated with any device such as an end cap, refrigerator, light bank, electronic advertisement, electronic signage, or the like.

Once the electrified track 1002 is installed, the electrified track 1002 makes it relatively straightforward for an employee 302 of the store or a third party contractor (not shown) to connect a power cord 1004 or a power track 1008 to the electrified track 1002. For example, as illustrated for the power cord 1004, the employee 302 can use an installation pole 1006 to connect one end of the power cord 1004 to the electrified track 1002. The power track 1008 can be rigid, allowing the power track 1008 to be manipulated into the electrified track 1002 without the use of an installation pole 1006. The power cord 1004 and power track 1008 can electrically connect and be physically secured to the electrified track 1002 using any suitable mechanism. In various configurations, the connection point 1010 can utilize rotation, magnetic coupling, pressure coupling, detents, and so forth to ensure both reliable electrical conduction and secure physical attachment as would be understood in the art. The connection point 1010 can be suitably configured such that the electrified track 1002 and power cord 1004 or power track 1008 can be mated by an employee 302 while standing on the floor of the store, without a ladder, but also be released or uncoupled at a future time if the marketing display 100 is to be moved to a different shelf 110 or position in the store.

In various configurations, the power delivery end 1012 of the power cord 1004 or power track 1008 can terminate in one or more computer power plugs, for example IEC320 plugs for connection into the marketing display 100, or have one or more sockets, such as NEMA 5-15R sockets. Other standard, or proprietary, connections can also be used as would be understood by one of ordinary skill in the art.

It should be appreciated that the electrical connection system 1000 enables the channeling of power from one or more existing outlets in the ceiling of a retail location to one or more locations within the floor. For example, in some embodiments, the electrical connection system 1000 can be used to distribute power from locations that typically always have power in a retail store (the pharmacy, the refrigerated area, etc.) to locations that rarely do, such as the center of the retail store. In doing so, power can be easily and economically distributed to more locations with a retail store (e.g., grocery stores, drug stores, super-stores, etc.) without requiring installation of a new outlet, which is often difficult and expensive because it typically requires running a line potentially hundreds of feet through the ceiling back to the retail store's nearest breaker box.

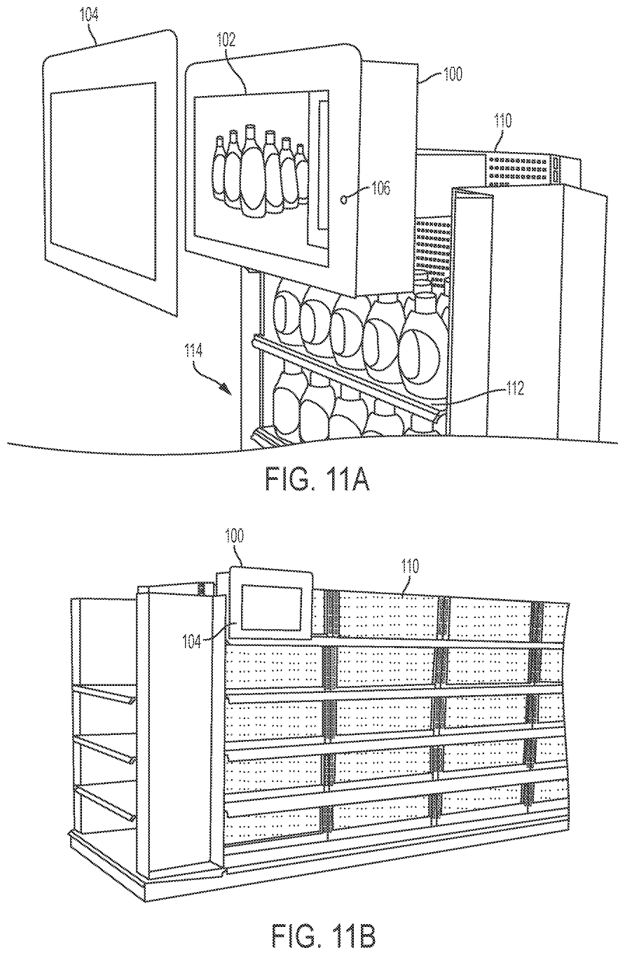

Referring now to FIG. 11A, an exploded drawing of a marketing display 100 is presented. The marketing display 100 includes a display screen 102, a camera sensor 106, and a removable surround 104. In various configurations, the surround 104 can adhere to the bezel of the display screen 102 or the front face of the marketing display 100 using, for example, magnetic coupling, contact adhesion, or any other suitable non-permanent adhesive means as would be understood by one of ordinary skill in the art. The marketing display 100 can be configured to be mounted in a multi-level shelf 110, for example an end cap that has multiple shelf trays 112 for display of consumer products 114.

Referring now also to FIG. 11B, an isometric drawing of a marketing display 100 in the isle portion of a multi-level shelf 110 is presented. The marketing display 100 is shown with the surround 104 secured in place on the marketing display 100.

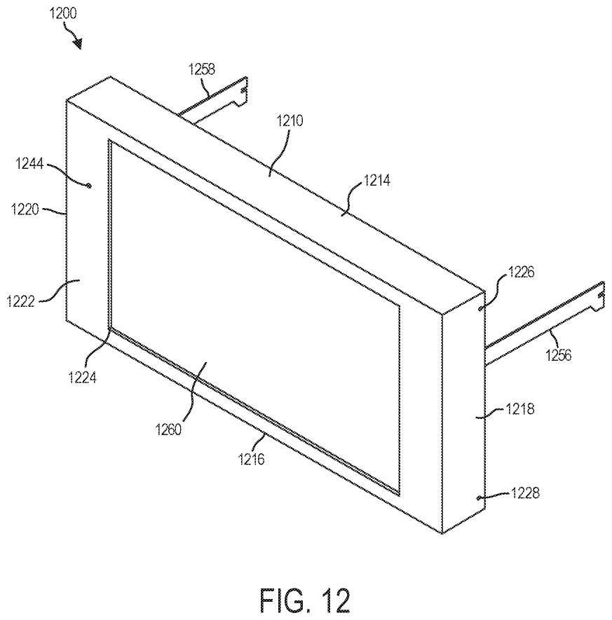

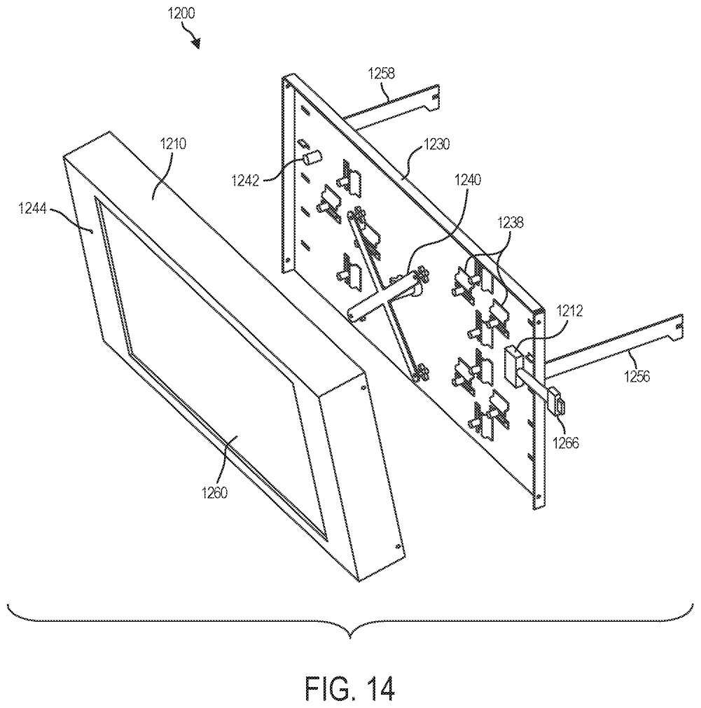

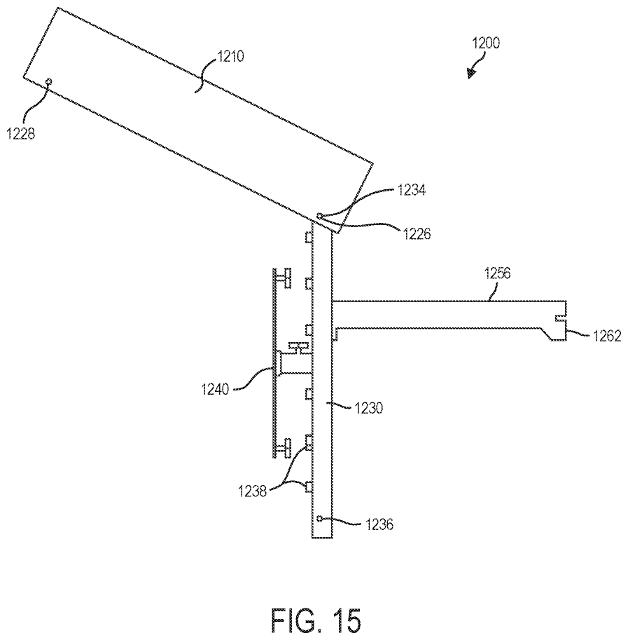

Referring now to FIGS. 12-15, an exemplary modular marketing display assembly 1200 is shown. It should be appreciated that the modular marketing display assembly 1200 can include functionality and/or components similar to any of the functionality and/or components of the marketing display 100 described herein. As illustratively shown, the modular marketing display assembly 1200 includes a display frame 1210, a display device 1260, and a controller 1212 (FIG. 14). The display device may be embodied as any type of display device or display screen capable of performing the functions described herein. For example, the display device 1260 may be embodied as any type of device capable of displaying information (e.g., product information, advertising information, inventory information, price information, stocking diagrams, etc.) to consumers, employees, or any other type of individual in proximity to the modular marketing display assembly 1200. To do so, in some embodiments, the display device 1260 can receive the information to be displayed from the controller 1212, which can be communicatively coupled thereto. It should be appreciated that the display device 1260 may include, or otherwise use, any suitable display technology including, for example, a liquid crystal display (LCD), a light emitting diode (LED) display, a cathode ray tube (CRT) display, a plasma display, and/or any other type of display device or technology usable in the modular marketing display assembly 1200 to display information to nearby individuals.

The controller 1212 of the modular marketing display assembly 1200 may be embodied as any type of computing device capable of performing the functions described herein. For example, the controller may be embodied as a microcomputer, a minicomputer, a laptop computer, a mobile computing device, a handheld computer, a smart phone, a tablet computer, a personal digital assistant, a custom chip, an embedded processing device, or any other type of computing device and/or suitable programmable device. As such, the controller may include devices and structures commonly found in a computing device such as processors, memory devices, communication circuitry (e.g., wireless or wired local area network circuitry, wide area network circuitry, cellular communication circuitry, etc.) and data storages, which are not shown in FIGS. 12-16 for clarity of the description.

The display frame 1210 of the modular marketing display assembly 1200 can include a top surface 1214, a bottom surface 1216, a first side 1218, and a second side 1220, and a front surface 1222. The display frame 1210 can have a substantially rectangular configuration or any other suitable shape such as cylindrical, oval, pyramid, or the like. The display frame 1210 can be constructed from any suitable material such as steel, plastic, metal, aluminum, or the like. The display frame 1210 can be molded or otherwise formed as an integral unit or, in an alternate version, the display frame can include a plurality of surfaces and components that are coupled to form the display frame.

The front surface 1222 can define a substantially rectangular aperture 1224 that can be shaped such that the display device 1260 is visible therethrough. The aperture 1224 can, in one embodiment, be filled with a transparent or semi-transparent screen or plate such that the display device 1260 is not directly accessible to a consumer or the like. In an alternate embodiment the aperture 1224 can permit a user to touch the display device 1260 such as, for example, where the display device 1260 is a touchscreen or interactive display. It will be appreciated that the aperture 1224 can have any suitable shape or dimension such that the visible display device 1260 can have the desired visual effect on a consumer, employee, etc. In an alternate embodiment the front surface 1222 can include a plurality of apertures that can accommodate a plurality of display devices to create a different visual effect.

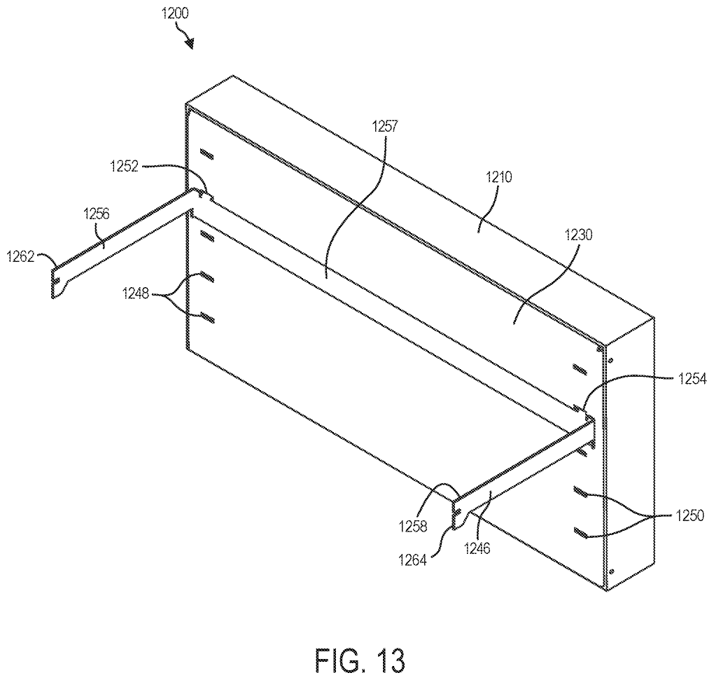

The display frame 1210 can define a pivot aperture 1126 and a fastener aperture 1228 that can be used to couple the display frame 1210 to a rear closure panel 1232 (FIG. 13). The pivot aperture 1126 can be sized to accept a pin 1234 (FIG. 16) coupled with the rear closure panel 1232 such that the display frame 1210 can pivot relative to the rear closure panel 1232. The pin 1234 can be fixedly coupled with the display frame 1210 and rear closure panel 1232 such that the display frame 1210 and the rear closure panel 1232 have a substantially hinged relationship from an open position (FIG. 16) to a closed position (FIG. 12). In an alternate embodiment, the rear closure panel 1232 can be selectively detachable from the display frame 1210. The fastener aperture 1228 can include a fastener 1236 that can selectively couple the display frame 1210 to the rear closure panel 1232 in the closed position. The fastener 1236 can be a threaded screw, a snap fit, a friction fit, or any other suitable connector. In one version, the fastener 1236 can be permanently coupled with at least one of the display frame 1210 or rear closure panel 1232 such that hardware is not easily lost. It will be appreciated that the presently described example is hinged near the top of the display frame 1210, but that the components can be easily reversed such that the display frame is hinged to open near the bottom of the display frame. Other configurations to open the display frame are contemplated such as having a hinge on the side of the frame, sliding the frame over the rear closure panel, or the like. It will also be appreciated that in one embodiment the rear closure panel can be integrally formed or otherwise coupled with the display frame such that the front surface is hinged or can otherwise be opened to access the cavity defined by the display frame.

The rear closure panel 1230 can be a substantially planar surface and can include a plurality of attachment features such as brackets 1238, a VESA connector 1240, or the like. It will be appreciated that any suitable number and type of attachment features are contemplated for the attachment of a variety of components. The controller 1220 can be fixedly or removably attached to the rear closure panel 1230. The VESA connector 1240 can be a mount for the display device 1260 in such a manner that the display device 1260 is adjustable within the display frame 1210 to the correct position. The rear closure panel can include a mount for wiring, a battery, communications systems, a camera, sensors, or the like. Referring to FIG. 14, the rear closure panel 1230 can include a camera 1242 that can be positioned relative to an aperture 1244 defined by the display frame 1210 such that the camera 1242 can view consumers, employees, or the like. The display frame 1210 can include any suitable number of apertures associated with cameras, lights, sensors, motion sensors, microphones, speakers, or the like. In one embodiment the rear closure panel includes a plurality of quick connect fasteners such that components used with the modular display assembly 1200 can be easily connected, removed, or interchanged. Each of the fasteners and/or components can be clearly marked for ease of use. It will be appreciated that the module and components associated with the model can provide music, sound, or any other auditory output.

With reference to FIG. 13, the rear closure panel 1230 can be selectively coupled with an adjustable bracket 1246. The rear closure panel can include a first substantially vertical row of apertures 1248 and a second substantially vertical row of apertures 1250 such that a first flange 1252 and a second flange 1254 of the bracket 1246 can mate with at least one of the apertures in the first row of apertures 1248 and the second row of apertures 1250, respectively. Each of the apertures in first row of apertures and second row of apertures 1250 can be substantially horizontally aligned such that when the bracket 1246 is engaged the modular display assembly 1200 is substantially level on a horizontal plane.

The bracket 1246 can include a crossbar 1257 associated with the first flange 1252 and the second flange 1254 and a first lateral arm 1256 and a second lateral arm 1258. The lateral arms 1256, 1258 can be substantially parallel and aligned along a horizontal plane when engaged with the modular display assembly 1200. The first lateral arm 1256 can include a first coupling 1262 and the second lateral arm 1258 can include a second coupling 1264, where the couplings 1262, 1264 can engage with an existing shelving unit, modular shelving unit, store shelf, or the like such that the modular display assembly 1200 can be mounted in a desirable location. The lateral arms 1256 can be spaced apart any suitable distance such as, for example, from about one foot to about five feet, from about two feet to about four feet, from about two feet to about six feet, or the like. The arms 1258, 1264 can have any suitable couplings 1262, 1264 such as flanges, hooks, hook and loop fasteners, adhesives, suction cups, or the like. It will be appreciated that the bracket 1246 is described by way of example only, where any suitable fastener for attaching the modular display assembly 1200 to a shelf, modular unit, end cap, or the like is contemplated. The bracket 1246 can be formed from a single piece of metal or can include a plurality of components.

Embodiments of the modular display assembly 1200 can include a casing that can accept or otherwise be used with a commercially available consumer-grade screen, a commercially available CPU, and a signal-receiving device to create a digital signage solution with interchangeable components. In one embodiment, the display device 1260 can mount to a VESA mount or to a system of clamps that hold it firmly in place. Optionally, a buffer material can be used to connect the case or frame to the edge of the display or monitor screen with a soft and flexible material such as rubber or accordion-style plastic. The VESA mount can be moved by hand to ensure the display screen properly aligns within the casing or frame and the entire mounting mechanism can be tightened into place by hand or with a simple tool, for example. There back panel or rear closure panel 1230 on the casing or display frame 1210 can include adjustable brackets to hold in place a CPU which can be connected to the screen via a USB or HDMI cable (e.g., cable 1266 shown in FIG. 14). Additional adjustable brackets are available for holding in place power supplies and other components. The back-panel of the casing or frame can be removed with a simple tool, such as an Allen wrench or screwdriver. With the panel removed, any of the component elements can easily be swapped out with a replacement of the some or a different manufacture and model, according to one embodiment.

In one embodiment, the modular display assembly 1200 is an all-in-one structure that can ship to a retail store in a single box and can be installed by an individual already working in the retail store. Example features can include an all-encompassing tamper-proof case that encloses a screen along with all other components necessary to control the content on the screen remotely. The modular display assembly can include a 16×9 digital screen that operates at under 300 Watts. The controller 1212 can be a small computing device capable of storing content (images, sound, and video). This modular display assembly 1200 can arrive at the retail location pre-loaded with software and associated algorithms that can determine what content should run on the screen based on a given set of conditions (i.e., time of day, date, geography, etc.). The modular display assembly 1200 can include hardware that enables connectivity via a cell-phone connection such as a cell-phone modem or dongle. Such a connection can already be established and operational upon the unit's arrival to the retail store, for example. The modular display assembly can include cameras, i-beacons, and other sensors. In one embodiment, a port (not shown) can allow for the connection of an optional external antenna to enable better signal reception in a location that has poor cell reception. The modular display assembly 1200 can include an on/off master switch (not shown) that can allow a person to turn off all of the components with one action, without having to open the enclosure or display frame. The total weight of the enclosure and all of its component parts of the modular display assembly 1200 can be less than 30 pounds. The modular display assembly 1200 can weigh from about ten pounds to about 20 pounds, from about fifteen pounds to about third pounds, from about five pounds to about fifty pounds, or any suitable weight. The display frame, such as display frame 1210, can be made to fit with a bracket that is custom-designed to fit a certain retailer's existing fixtures. Variations of this bracket, such as bracket 1246, can be sized to fit shelf widths of 2, 3, 4, and 5 feet wide, for example. The modular display assembly 1200 and all of its components can arrive at the retail location completely functional and ready for operation. Once the unit is attached to a retail fixture and plugged in, no additional work may be needed in order for the unit to perform properly. The unit can be easily installed by people who already work in the retail store in one embodiment. Such persons can be direct employees of the retailer or a retail service provider sub-contractor. No technical skill may be required to install the digital signage unit in one embodiment as it can simply be affixed to the existing retail fixtures and then automatically turn on and start running properly once plugged in. It will be appreciated that the tamper-proof case that can be associated with the modular display assembly 1200 can include an enclosure made out of metal, plastic or another similarly protective substance and structured in such a way that an unauthorized person could not access the interior of the case. The modular display assembly may be a substantially “plug & play” digital signage solution that can enable any average non-technical person to simply attach the display unit to a retail fixture and then have it run without issue or extra work. The modular display assembly 1200 may be useful because it can allow a brand or retailer to cost-effectively deploy a large volume of units in an extremely tight window of time.

In some embodiments, the marketing display assembly 1200 can function as a digital signage device to retrieve and display location-specific advertisements. The advertisements retrieved and displayed by the digital signage device can also be based on various location-specific factors such as, for example, the weather forecast, pollen count, or ethnic makeup of the neighborhood in a specific location. To do so, the digital signage device (i.e., the modular marketing display assembly 1200) can include cellular communication circuitry, which can be configured to provide data connectivity to the digital signage device.

In operation, the controller of the digital signage device (i.e., the modular marketing display assembly 1200) can utilize the cellular communication channel (and any associated infrastructure) to establish a communication channel with a remote content source (e.g., a remote server) and retrieve location-specific advertising content therefrom. To do so, in some embodiments, the controller communicates with the remote content source via a predetermined or reference Uniform Resource Locator (URL) maintained or otherwise managed by the remote content source (e.g., a remote advertising network server, an advertising content generation server, etc.). The reference URL may be tagged and include an identifier associated with the controller of the digital signage device. In some embodiments, the identifier of the controller can be configured to uniquely identify the controller. In other embodiments, the identifier can be configured to identify a group of controllers within which the controller of the digital signage device belongs. As such, the identifier can be embodied as, or otherwise indicative of, a specific address, a specific store type, a region, a controller type, a display type, a capable screen resolution, hardware capabilities, or any other type of information suitable for grouping and/or categorizing controllers and/or digital signage devices.

Using the reference URL, the controller of the digital signage device downloads and locally caches the appropriate advertising content to be displayed. In some embodiments, the advertising content can be in a 16×9 format or any other format suitable for display via the digital signage device. It should be appreciated that the remote content source can be configured to selectively provide advertising content based on the reference URLs accessed by one or more digital signage device controllers. For example, based at least in part on the specific reference URLs accessed, the remote content source can be configured to provide a first item of advertising content to digital signage device controllers of first group and a second item of advertising content to digital signage device controllers of a second group. Additionally or alternatively, the remote content source can be configured to selectively provide advertising content based on the location of the requesting digital signage device controller, which can be determined based on location data received during establishment of the cellular communication channel by the controller and/or received from the controller using any other suitable geolocation technique (e.g., GPS, signal triangulation, wireless network SSIDs, etc.). In some embodiments, the remote content source can obtain the advertising content and/or updated advertising content from a third-party content generation server. In such embodiments, the remote content source can be configured to periodically receive the advertising content that is to be provided to the digital signage device controller from the third-party content generation server.

In some embodiments, the controller of the digital signage device is configured to periodically download an advertising template from a first remote content source (e.g., a remote advertising network server). The advertising template can include one or more visual objects for display via the digital signage device. In some embodiments, the advertising template may be embodied as an HTML webpage including one or more frames, portals, windows, sections, or any other type of area within which an advertisement received from a second remote content source (e.g., a third party advertising generation server) can be displayed. Such frames, portals, windows, sections, and other area types within the advertising template can be linked to, or otherwise associated with, the second remote content source (e.g., the third party advertising generation server). In such embodiments, the digital signage device can be configured to download the advertising template from the first remote content source (e.g., the remote advertising network server) and subsequently download advertising content directly from the second remote content source (e.g., the third party advertising generation server) for display within the frames, portals, windows, sections, or other areas of the advertising template. In that way, the first remote content source (e.g., the advertising network server) can control the layout of the advertising template and thereby maintain control of the overall “look and feel” of advertising content displayed via the digital signage device.

In some embodiments, the controller of the digital signage device periodically queries the remote content source (e.g., the remote advertising network server, the advertising content generation server, etc.) to determine whether new advertising content exists. To do so, the controller can be configured to periodically access the reference URL and determine whether the remote advertising content has changed. In embodiments in which the controller determines that new advertising content exists, the controller can be configured to download and locally cache the new content for subsequent display. In embodiments in which the controller determines that new advertising content does not exist, the controller can be configured not to download the advertising content and instead wait until the next interval.

In a specific non-limiting embodiment, a digital signage device (i.e., the modular marketing display assembly 1200) can be installed at a retail establishment located at 1234 Retail Lane, Retail, NC 32151. In such embodiment, each time the controller of the digital signage device pings (e.g., accesses, queries, etc.) a reference URL associated with the digital signage device (or a group of digital signage devices), the remote content source (e.g., the remote advertising network server) can receive geolocation data generated during establishment of the cellular communication channels by the controller. For example, when the controller of the digital signage device pings the reference URL, the remote content source can receive data that indicates that the controller, and therefore digital signage device, is located at or near 35°44′40.1″N 78°52′39.8″W. Based at least in part on the reference URL pinged or accessed by the controller of the digital signage device, the remote content source can be configured to provide advertising content appropriate to the local weather for that specific location. For example, when it is sunny in the location at which the digital signage device is located, the remote content source can provide, and the controller can download, an advertisement for sunblock for subsequent display. In another example, when it is rainy in the location at which the digital signage device is located, the remote content source can provide, and the controller can download, an advertisement for umbrellas for subsequent display. It should be appreciated that, in some embodiments, the provision and downloading of such location-specific advertising content does not require human intervention and can therefore be completely automated.

In some embodiments, the digital signage device (i.e., the modular marketing display assembly 1200) and/or any number of digital signage devices can be configured to communicate with a digital signage network configured for a promoting brand. In such embodiments, digital signage network is configured to provide advertising content specific to a particular brand to the digital signage device(s), which may be located in various different retailers or types of retailers. It should be appreciated that such a digital signage network is not a conventional advertising network or a conventional retailer network. Rather, the digital signage network can be established on behalf of a specific paying brand client to communicate messaging (e.g., advertisements, new advertising content queries, etc.) between a remote advertising network server (or other remote device) and the digital signage device(s). Such messaging can be associated with, or otherwise correspond to, retail products that are physically placed in close proximity to the digital signage device(s). In some embodiments, a planogram or any other form of retail space management data for each retailer (or each specific store location) can be used to determine the products in close proximity to the digital signage device(s). Additionally, in some embodiments, the digital signage network can be established to communicate other types messaging (e.g., configuration data, software and/or firmware packages, location information, device health information, etc.) between the remote advertising network server (or other remote device) and the digital signage device(s) on behalf of the specific brand client. For example, in embodiments where the digital signage device (i.e., the modular marketing display assembly 1200) is tamper-proof and/or not easily accessible when installed at a retail location, the digital signage device can be controlled remotely by the digital signage network or any type of computing device communicatively coupled thereto. It should be appreciated that such configuration prevents employees of the retail location and/or any other individual (e.g., consumers, mischievous teenagers, competitors, etc.) from controlling functionality of the digital signage device and/or changing the advertising content displayed thereon.

Additionally or alternatively, in some embodiments, the digital signage device (i.e., the modular marketing display assembly 1200) and/or any number of digital signage devices can be configured to communicate with a special-purpose digital signage network. The special-purpose digital signage network can be configured to enable communications between the digital signage device(s), the remote advertising network server, a remote third-party advertising content generation server, and/or any other type of computing device configured to manage and/or interact with the digital signage device(s). For example, in some embodiments, a special-purpose digital signage network can be configured to enable the transfer of advertising content and/or management data between the digital signage device(s) and the remote advertising network server (or any other type of remote server) via cellular communication channels and networks thereby eliminating the need for communications via other types of communication channels and networks (e.g., a WiFi® network, a Bluetooth® network, a wired communication network, etc.) that may either be unavailable or unreliable at one or more retail locations.

In some embodiments, the remote advertising network server (or another management computing device) is configured to remotely manage features and/or software executed by the digital signage device(s). For example, in some embodiments, the remote advertising network server (or another management computing device) can be configured to remotely change features and/or functionality of the digital signage device(s) communicatively coupled thereto via a digital signage network or another type of network using wired network communication channels, wireless network communication channels (e.g. cellular communication channels, short range wireless communication channels, long range wireless communication channels, etc.). Additionally or alternatively, the remote advertising network server (or the other management computing device) can be configured to add, remove, and/or update new or existing software and/or firmware executed by the digital signage device(s) communicatively coupled thereto.

The digital signage device (i.e., the modular marketing display assembly 1200) and/or any number of digital signage devices can also be configured to interact with automated or semi-automated inventory tracking and action systems operating independent of a point of sale (POS) system or point of purchase (POP) systems of a retailer. That is, the digital signage device(s) can be configured to generate snapshots (e.g., images, video data, etc.) of current product inventory at specific retail locations either on-demand or according to a reference schedule. Such snapshots can be analyzed to determine current product inventory levels at different retail locations. To do so, the digital signage device(s) can include a digital camera, or any other type of digital image/video generation mechanism, configured to capture images of the products placed on (or absent from) a retail shelf at a retail location. The captured images can be tagged with identifiable characteristics such as the image capture date, the image capture time, the location of the retail store, the location of the digital signage device (or digital camera) within the retail store, and/or any other identifiable characteristic or data associated with the digital signage device, the digital camera, or a particular product. In some embodiments, the identifiable characteristics can be included with each captured image as metadata. It should be appreciated that subsequent images of a particular product are captured from a substantially similar viewpoint of the retail shelf As a result, raid analysis and quality control of products can be quantitatively and qualitatively tracked at scale via the automated and/or semi-automated process. For example, using subsequently captured images, it can be determined whether products are pulled to the front of the shelf versus left in the back, or whether they are oriented in the proper position (i.e., upright versus laying on their sides).

In some embodiments, the captured images can initially be stored locally in memory or some other form of local storage of the digital signage device. Thereafter, the digital signage device can transmit the captured images to a remote server such as, for example, the remote advertising network server for analysis and further processing. The locally-stored images can be transferred by the digital signage device in response to a request received from the remote advertising network server and/or according to any other schedule or event (e.g., a reference time interval, occurrence of an event, etc.). In some embodiments, the locally-stored images are transmitted by the digital signage device to the remote advertising network server via a cellular communications channel. It should be appreciated that in some embodiments, the digital camera (or any number of digital cameras) may be separate from the digital signage device. For example, in some embodiments, one or more digital cameras can be installed proximate to the retail shelf at the retail location. Such digital cameras can be configured to transmit the captured images to the remote advertising network server.

Upon receipt, the remote advertising network server can be configured to categorize and make accessible the captured images received from the digital signage device. To do so, in some embodiments, the remote advertising network server can utilize a central database or any other suitable form of data store or repository. Thereafter, the remote advertising network server can process the received images to determine if the proper products are present and, if so, what the inventory count is for each product. In some embodiments, the remote advertising network server can utilize image recognition and/or any suitable form of image-analytics and/or video-analytics to recognize products and determine corresponding inventory counts. The inventory count data for a particular product, and any other data (e.g., quantitative and/or qualitative data) resulting from the analysis of the captured images, can be stored in the central database in association with the identifiable characteristics of the product. In some embodiments, the data and images stored in the central database can be manipulated (e.g., updated, appended to, deleted, etc.) via interactions with the remote advertising network server. Additionally, in some embodiments, the remote advertising network server or any other type of computing device communicatively coupled thereto can generate consolidated inventory reports configured that can be provided product manufacturers or other interested entities. It should be appreciated that the product manufacturers can utilize the consolidated inventory reports to make informed decisions and take action on the information provided. It should be appreciated that, in some embodiments, the generation and provision of such consolidated inventory reports does not require human intervention and can therefore be completely automated and performed at any day or time. It should be further appreciated that such functionality can be performed independent of POS or POP systems of the retailer. As such, the integration complexity of the digital signage device(s) within a retail environment can be reduced and the inventory tracking capability can be activated with zero integration complexity for the retailer's organization.

Some of the figures can include a flow diagram. Although such figures can include a particular logic flow, it can be appreciated that the logic flow merely provides an exemplary implementation of the general functionality. Further, the logic flow does not necessarily have to be executed in the order presented unless otherwise indicated. In addition, the logic flow can be implemented by a hardware element, a software element executed by a computer, a firmware element embedded in hardware, or any combination thereof.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto. Various changes, alternatives, and modifications will become apparent to a person of ordinary skill in the art after a reading of the foregoing specification. It is intended that all such changes, alternatives, and modifications that fall within the scope of the appended claims be considered part of the present disclosure.

What is claimed is:

1. A modular display comprising:
a. a display body, the display body having a substantially vertical orientation and a top and a bottom, wherein the display body includes;
1. a first substantially vertical support;
11. a second substantially vertical support, the second substantially vertical support being spaced apart and substantially parallel to the first substantially vertical support; and
111. a first shelf, wherein the first shelf is selectively coupled with the first substantially vertical support and the second substantially vertical support;
b. a first sensor, wherein the first sensor is coupled with the first shelf;
c. a display assembly, the display assembly being positioned at about the top of the display body, the display assembly including;
1. a display frame, wherein the display frame is selectively coupled with the display body;
11. a display screen, wherein the display screen is at least partially retained by the display frame;
111. a controller, wherein the controller is programmable to display content on the display screen.
